(19) United States
(12) Patent Application Publication
(10) Pub. No.: US 2026/0229413 A1
(43) Pub. Date: Aug. 6, 2026

(54) MULTILAYER CERAMIC CAPACITOR

(71) Applicant: Murata Manufacturing Co., Ltd., Nagaokakyo-shi (JP)

(72) Inventor: Yuu MIKAMI, Nagaokakyo-shi (JP)

(21) Appl. No.: 19/636,025

(22) Filed: Apr. 1, 2026

Related U.S. Application Data
(63) Continuation of application No. PCT/JP2024/039456, filed on Nov. 6, 2024.

(30) Foreign Application Priority Data
Feb. 1, 2024 (JP) 2024-014056

(51) Int. Cl. H01G 4/232; H01G 4/30

(52) U.S. Cl. CPC H01G 4/2325; H01G 4/30

(57) ABSTRACT

A multilayer ceramic capacitor includes a multilayer body, first and second outer electrodes, an inner layer portion and two outer layer portions on opposite sides of the inner layer portion. The inner layer portion includes a first inner electrode with one end exposed at a third surface, a second inner electrode with one end portion exposed at a fourth surface, and an inner dielectric layer including at least Ca, Sr, or Zr, and Li. In a region of the first or second outer electrode within an approximately 15 μm square area from an interface between the multilayer body and the first outer electrode or the second outer electrode, a Li content in the first outer electrode and/or the second outer electrode is less than a Li content in the inner dielectric layer.

### CROSS REFERENCE TO RELATED APPLICATIONS

This application claims the benefit of priority to Japanese Patent Application No. 2024-014056 filed on Feb. 1, 2024 and is a Continuation Application of PCT Application No. PCT/JP2024/039456 filed on Nov. 6, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

As multilayer ceramic capacitors used in electronic devices, there are known a multilayer ceramic capacitor having a high dielectric constant and a temperature-compensating multilayer ceramic capacitor, as described in Japanese Unexamined Patent Application Publication No. 2018-24542, in which a change in capacitance relative to temperature change is linear.

For example, in the multilayer ceramic capacitor described in Japanese Unexamined Patent Application Publication No. 2009-7209, copper or an alloy including copper is used for the inner electrodes, and calcium zirconate is used as a main component of the dielectric layers. However, when copper is used for the inner electrodes, since its melting point is low, the inner electrodes may become excessively sintered in a step of sintering the dielectric material, and the effective area of the inner electrodes is reduced, causing a problem such as reduction in capacitance in some cases. In Japanese Unexamined Patent Application Publication No. 2009-7209, the temperature for sintering the dielectric material is lowered so that the temperature becomes as close to the temperature of copper as possible, and a sintering aid for forming a liquid phase during firing, such as lithium or silicon, is used.

### SUMMARY OF THE INVENTION

However, as also described in Japanese Unexamined Patent Application Publication No. 2019-62177, lithium is highly volatile. Thus, lithium volatilization has occurred in a step of sintering the dielectric material.

In addition to the above issue, for example, when copper is used for the outer electrodes, lithium in the dielectric material volatilizes in a step of sintering the outer electrodes and diffuses into the outer electrodes in some cases. When lithium is diffused into the outer electrodes, it may act as a sintering aid and excessively densify the outer electrodes, causing blisters or the like. Furthermore, moisture resistance of the multilayer ceramic capacitor may be reduced in some cases.

Example embodiments of the present invention provide multilayer ceramic capacitors in which an amount of lithium (Li) present in outer electrodes is appropriately controlled and degradation in moisture resistance is reduced or prevented.

A multilayer ceramic capacitor according to an example embodiment of the present invention includes a multilayer body including a plurality of laminated dielectric layers, a plurality of laminated inner electrodes, a first surface and a second surface opposed to each other in a lamination direction, a third surface and a fourth surface opposed to each other in a first direction orthogonal to the lamination direction, and a fifth surface and a sixth surface opposed to each other in a second direction orthogonal to the lamination direction and the first direction, a first outer electrode on the third surface of the multilayer body, and a second outer electrode on the fourth surface of the multilayer body. The multilayer body includes an inner layer portion and two outer layer portions on opposite sides of the inner layer portion in the lamination direction. The inner layer portion includes a first inner electrode with one end portion exposed at the third surface, a second inner electrode with one end portion exposed at the fourth surface, and an inner dielectric layer provided with the first inner electrode and the second inner electrode. The inner dielectric layer includes at least Ca, Sr, or Zr as a main component, and Li. In at least one of a region of the first outer electrode within an approximately 15 μm square area in the first direction from an interface between the multilayer body and the first outer electrode and a region of the second outer electrode within an approximately 15 μm square area in the first direction from an interface between the multilayer body and the second outer electrode, a Li content in the first outer electrode and/or the second outer electrode is less than a Li content in the inner dielectric layer.

In a multilayer ceramic capacitor according to an example embodiment of the present invention, since the inner dielectric layer includes at least Ca, Sr, or Zr as a main component, and Li, and, the Li content in the first outer electrode in a region within an approximately 15 μm square area in the first direction from the interface between the multilayer body and the first outer electrode is less than the Li content in the inner dielectric layer, reduction in moisture resistance of the multilayer body is reduced or prevented.

Example embodiments of the present invention makes it possible to provide multilayer ceramic capacitors in which the amount of lithium (Li) present in the outer electrodes is appropriately controlled and degradation in moisture resistance is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an example of a multilayer ceramic capacitor according to a first example embodiment of the present invention, illustrating its outer appearance.

FIG. 2 is a sectional view taken along line II-II in FIG. 1.

FIG. 3 is a sectional view taken along line III-III in

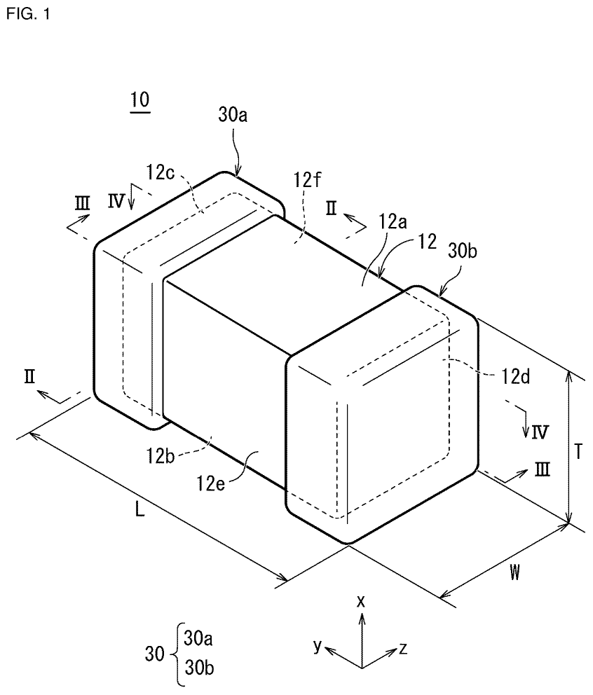

FIG. 1.

FIG. 4 is a sectional view taken along line IV-IV in FIG. 1.

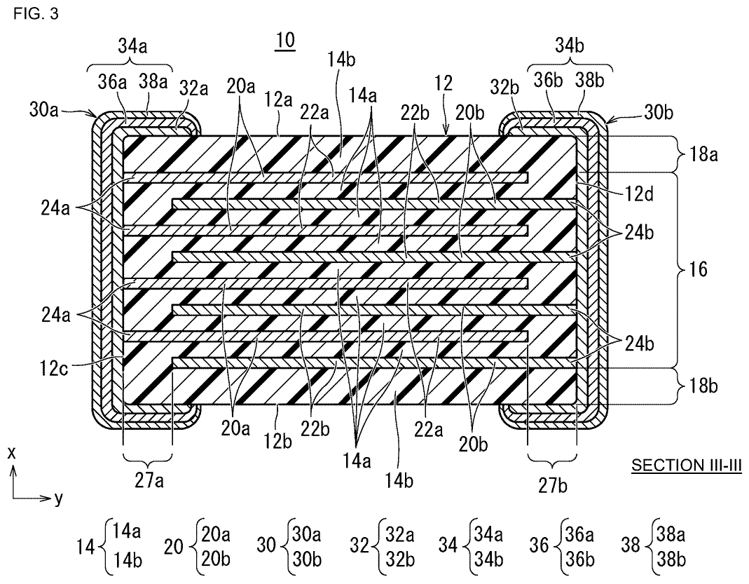

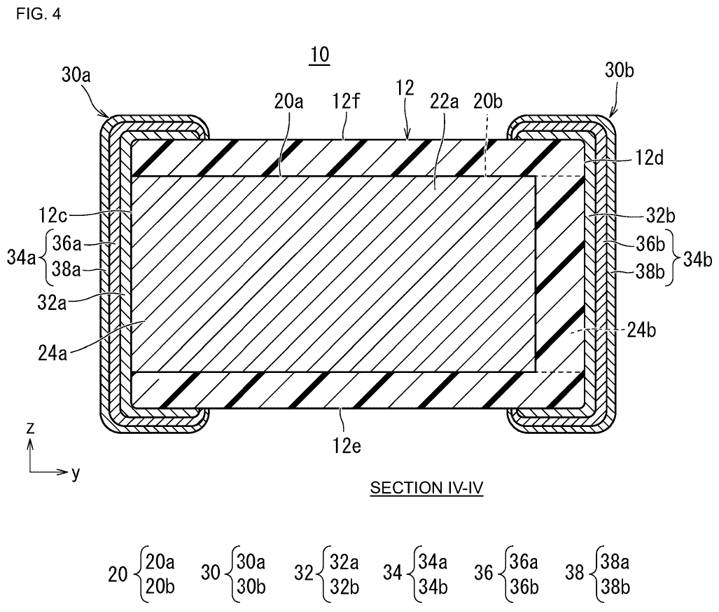

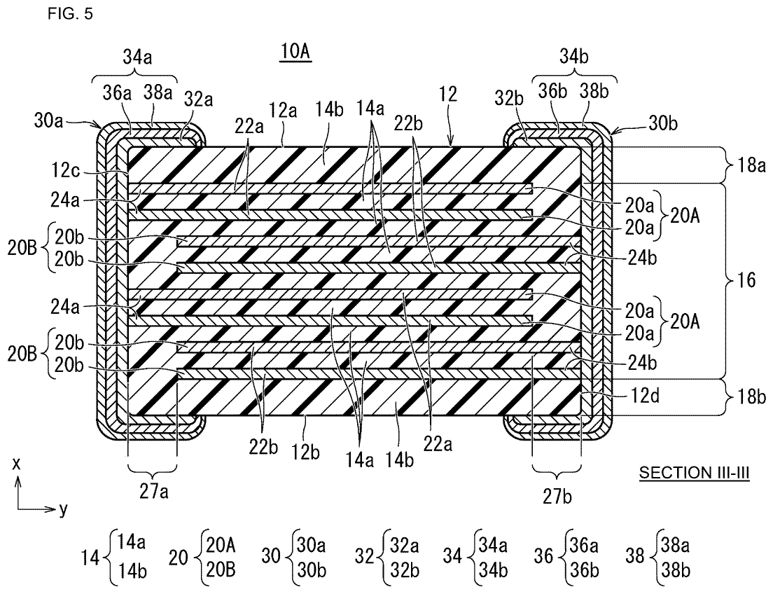

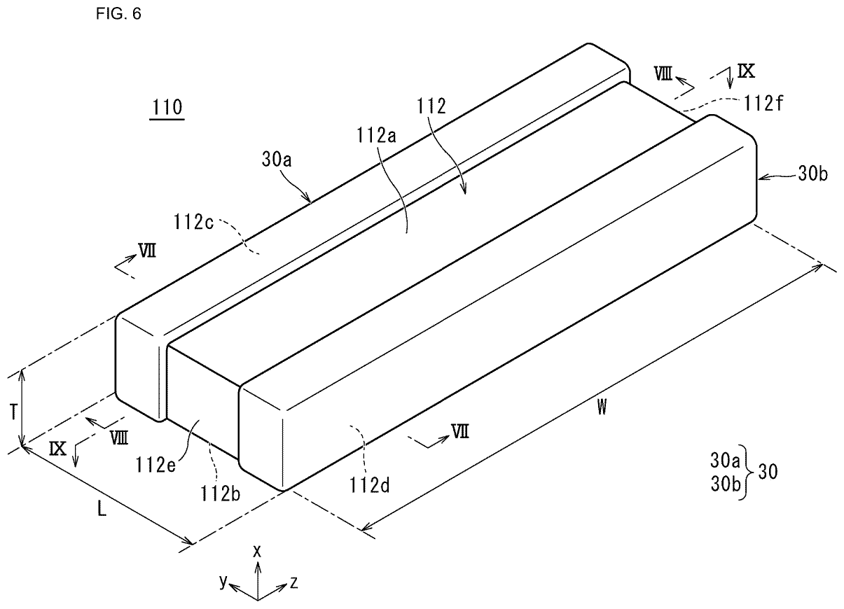

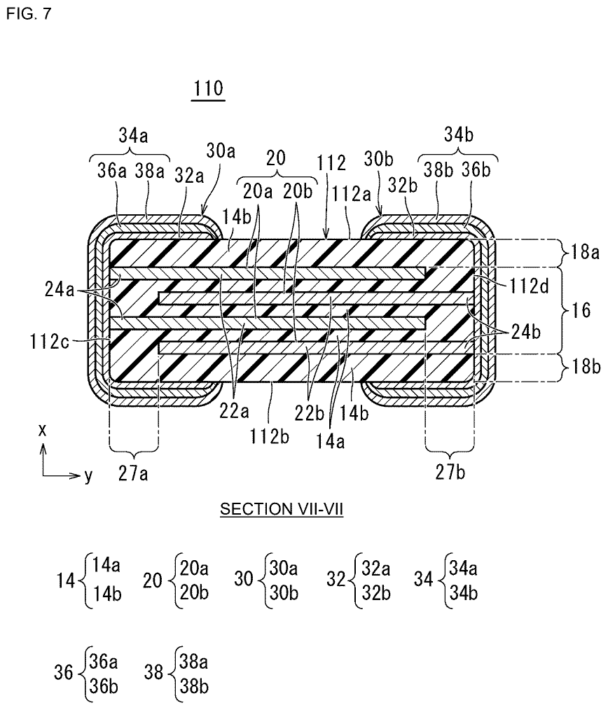

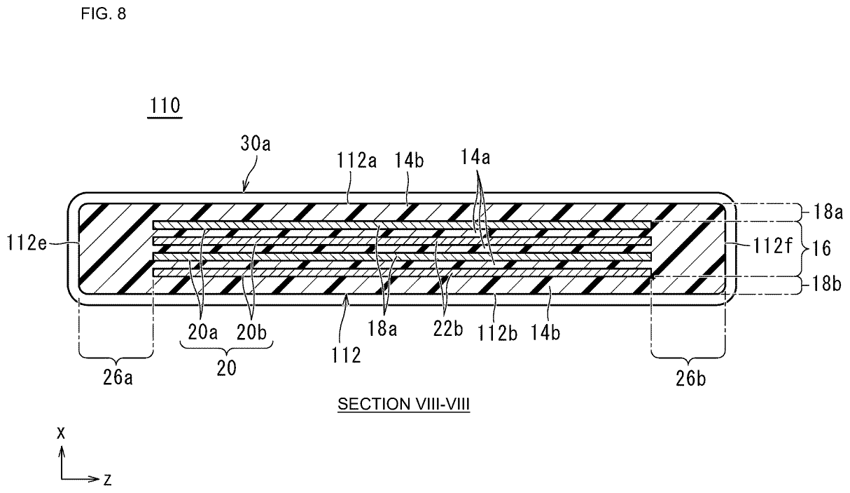

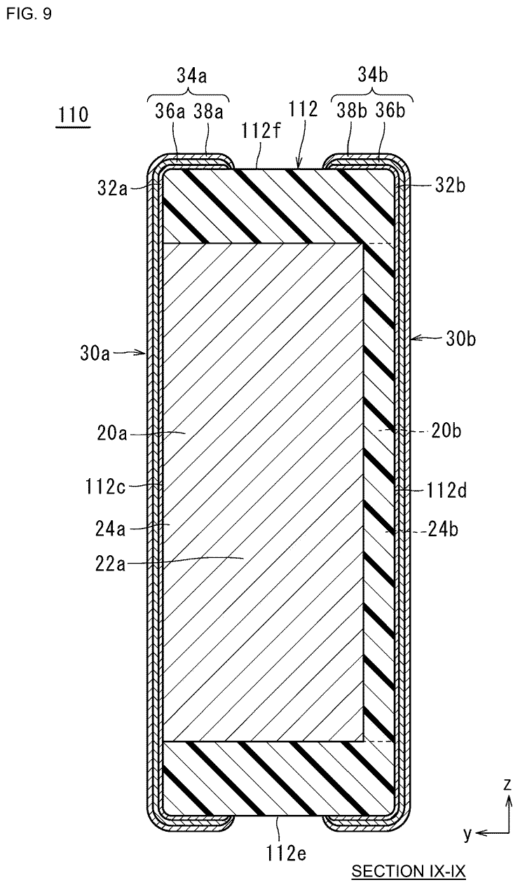

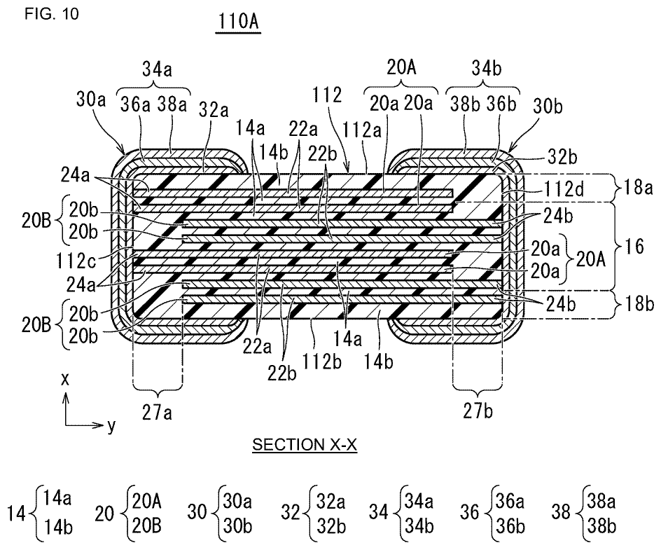

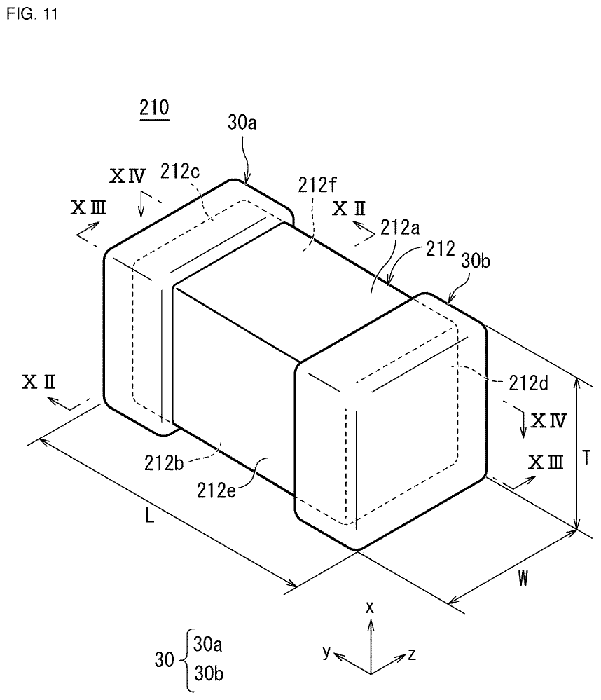

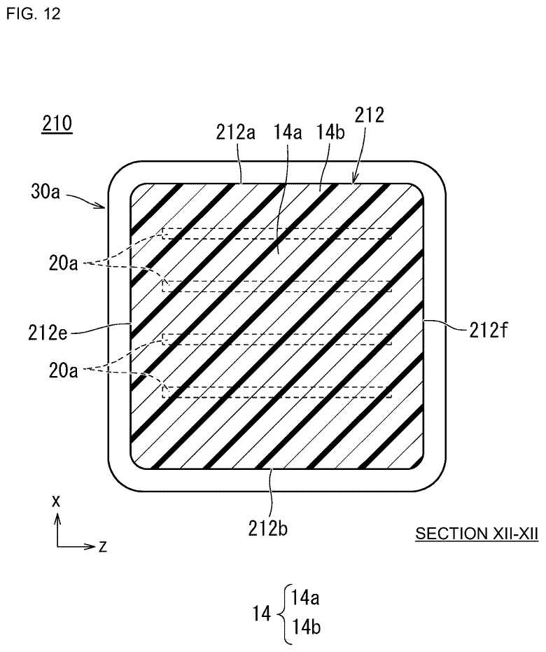

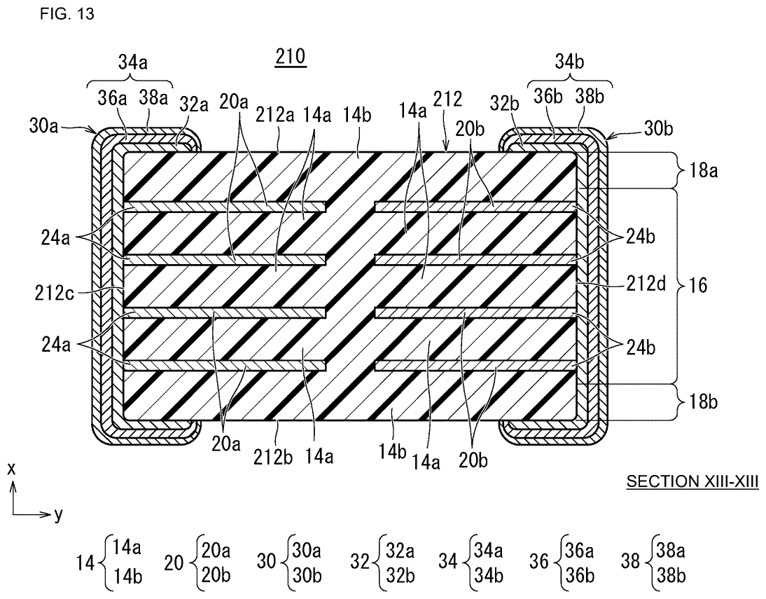

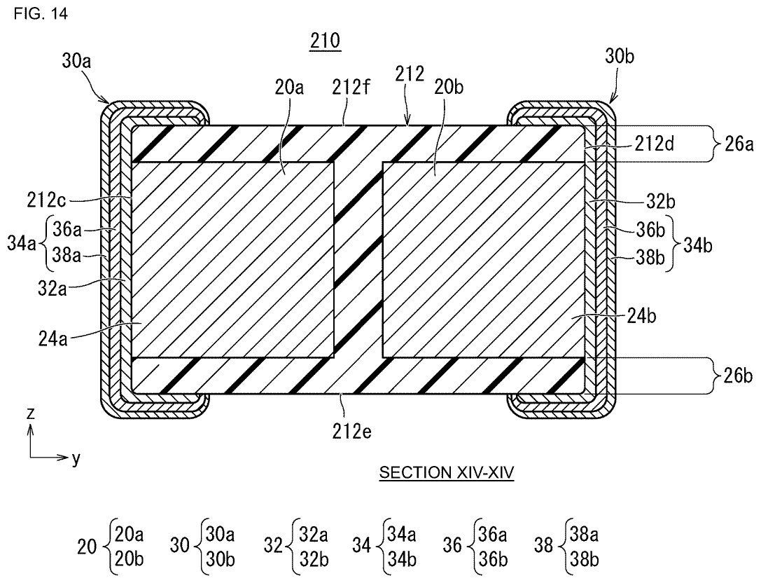

FIG. 5 is a sectional view of a modification of the first example embodiment, which corresponds to the sectional view of FIG. 3.

FIG. 6 is a perspective view of an example of a multilayer ceramic capacitor according to a second example embodiment of the present invention, illustrating its outer appearance.

FIG. 7 is a sectional view taken along line VII-VII in FIG. 6.

FIG. 8 is a sectional view taken along line VIII-VIII in FIG. 6.

FIG. 9 is a sectional view taken along line IX-IX in FIG. 6.

FIG. 10 is a sectional view of a modification of the second example embodiment, which corresponds to the sectional view of FIG. 7.

FIG. 11 is a perspective view of an example of a multilayer ceramic capacitor according to a third example embodiment of the present invention, illustrating its outer appearance.

FIG. 12 is a sectional view taken along line XII-XII in FIG. 11.

FIG. 13 is a sectional view taken along line XIII-XIII in FIG. 11.

FIG. 14 is a sectional view taken along line XIV-XIV in FIG. 11.

### DETAILED DESCRIPTION OF THE EXAMPLE EMBODIMENTS

Multilayer ceramic according to example embodiments of the present invention will be described.

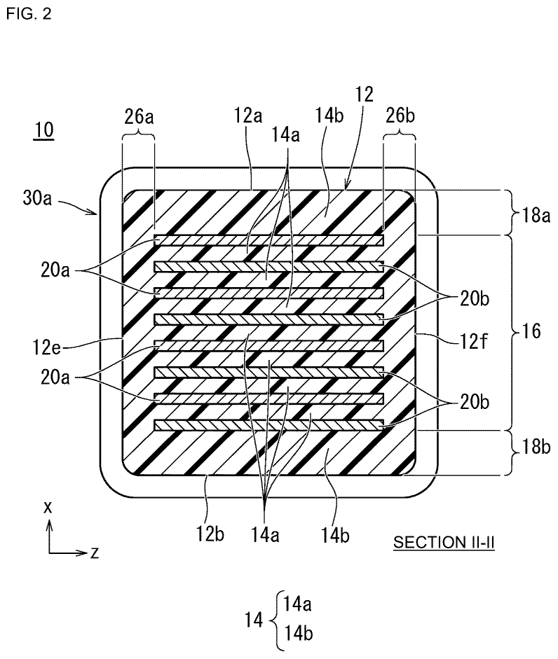

FIG. 1 is a perspective view of an example of a multilayer ceramic capacitor according to the first example embodiment of the present invention, illustrating its outer appearance. FIG. 2 is a sectional view taken along line II-II in FIG. 1. FIG. 3 is a sectional view taken along line III-III in FIG. 1. FIG. 4 is a sectional view taken along line IV-IV in FIG. 1.

As illustrated in FIGS. 1 to 3, the multilayer ceramic capacitor 10 includes a rectangular parallelepiped multilayer body 12 and outer electrodes 30 disposed at opposite end portions of the multilayer body 12.

The multilayer body 12 includes a plurality of laminated dielectric layers 14 and a plurality of inner electrodes 20 each laminated on the corresponding dielectric layer 14. The multilayer body 12 further has a first surface 12a and a second surface 12b opposed to each other in a lamination direction x, a third surface 12c and a fourth surface 12d opposed to each other in a first direction y orthogonal to the lamination direction x, and a fifth surface 12e and a sixth surface 12f opposed to each other in a second direction z orthogonal to the lamination direction x and the first direction y.

The first surface 12a and the second surface 12b, or one of these surfaces, are preferably flat. When a surface is flat, stress applied from a nozzle that picks up the multilayer ceramic capacitor 10 can be distributed over the flat surface. Hence, the strength of the multilayer ceramic capacitor can be improved in a mounting process.

The surfaces of the multilayer body 12 may be roughened.

The multilayer body 12 may include rounded vertex portions and rounded ridge line portions.

A portion where two of the first surface 12a, the second surface 12b, the third surface 12c, the fourth surface 12d, the fifth surface 12e, and the sixth surface 12f intersect is referred to as a ridge line portion, and a portion where three of these surfaces intersect is referred to as a vertex portion. The ridge line portions and the vertex portions are preferably rounded and have curvature. Ridge line portions and rounded vertex portions having curvature prevent chipping and cracking. When the multilayer body 12 includes ridge line portions and vertex portions with curvature, the main surfaces excluding the ridge line portions and the vertex portions may be flat.

As illustrated in FIGS. 2 and 3, the multilayer body 12 includes an inner layer portion 16 including dielectric layers 14 and inner electrodes 20 alternately laminated in the lamination direction x passing through the first surface 12a and the second surface 12b, a first-surface-side outer layer portion 18a including a plurality of dielectric layers 14 located between the first surface 12a and the inner electrode 20 closest to the first surface 12a, and a second-surface-side outer layer portion 18b including a plurality of dielectric layers 14 located between the second surface 12b and the inner electrode 20 closest to the second surface 12b.

The inner layer portion 16 includes a plurality of inner dielectric layers 14a out of the plurality of dielectric layers 14. Specifically, in the inner layer portion 16, the plurality of inner electrodes 20 face one another with the inner dielectric layers 14a interposed therebetween.

The inner dielectric layers 14a include at least Ca, Sr, or Zr as a main component, and Li. For example, the inner dielectric layers 14a include CaZro₃ or SrZro₃ as a dielectric component and include Li as a sintering aid. In addition, the inner dielectric layers 14a may include Mn, Na, Ti, and the like. The main component of the inner dielectric layers 14a can be observed as follows.

Specifically, the multilayer ceramic capacitor 10 is polished in the second direction z to a depth of about ½ of a W dimension in the second direction z to expose a cross section. Then, the exposed cross section is observed using TOF-SIMS (available from ION-TOF GmbH) under a condition of an approximately 30 μm square area.

As illustrated in FIGS. 2 and 3, the inner electrodes 20 include first inner electrodes 20a and second inner electrodes 20b. The first inner electrodes 20a and the second inner electrodes 20b are alternately laminated with the inner dielectric layers 14a interposed therebetween.

The first inner electrodes 20a are on a plurality of dielectric layers 14 and are located inside the multilayer body 12. Each first inner electrode 20a includes a first facing electrode portion 22a facing a second inner electrode 20b, and a first extended electrode portion 24a located at one end of the first inner electrode 20a and extended from the first facing electrode portion 22a to the third surface 12c of the multilayer body 12. The first extended electrode portion 24a has an end portion extended to the third surface 12c and exposed from the multilayer body 12. That is, the end portions of the first extended electrode portions 24a are not exposed at any of the first surface 12a, the second surface 12b, the fourth surface 12d, the fifth surface 12e, and the sixth surface 12f. Specifically, end portions of the first inner electrodes 20a are slightly recessed from the fourth surface 12d.

The shape of the first facing electrode portion 22a of the first inner electrode 20a is not particularly limited, but is preferably rectangular in plan view. As a matter of course, the corner portions in plan view may be rounded, or the corner portions may be positioned obliquely in plan view (tapered). The first facing electrode portion 22a may have a tapered shape in plan view with an inclination toward one side.

The shape of the first extended electrode portion 24a of the first inner electrode 20a is not particularly limited, but is preferably rectangular in plan view. As a matter of course, the corner portions in plan view may be rounded, or the corner portions may be positioned obliquely in plan view (tapered). The first extended electrode portion 24a may have a tapered shape in plan view with an inclination toward one side.

The width of the first facing electrode portion 22a of the first inner electrode 20a and the width of the first extended electrode portion 24a of the first inner electrode 20a may be the same, or one of the widths may be smaller than the other.

The second inner electrodes 20b are on a plurality of dielectric layers 14 and are located inside the multilayer body 12. Each second inner electrode 20b includes a second facing electrode portion 22b facing a first inner electrode 20a, and a second extended electrode portion 24b located at one end of the second inner electrode 20b and extended from the second facing electrode portion 22b to the fourth surface 12d of the multilayer body 12. The second extended electrode portion 24b has an end portion extended to the fourth surface 12d and exposed from the multilayer body 12. That is, the end portions of the second extended electrode portions 24b are not exposed at any of the first surface 12a, the second surface 12b, the third surface 12c, the fifth surface 12e, and the sixth surface 12f. Specifically, end portions of the second inner electrodes 20b are slightly recessed from the third surface 12c.

The shape of the second facing electrode portion 22b of the second inner electrode 20b is not particularly limited, but is preferably rectangular in plan view. As a matter of course, the corner portions in plan view may be rounded, or the corner portions may be positioned obliquely in plan view (tapered). The second facing electrode portion 22b may have a tapered shape in plan view with an inclination toward one side.

The shape of the second extended electrode portion 24b of the second inner electrode 20b is not particularly limited, but is preferably rectangular in plan view. As a matter of course, the corner portions in plan view may be rounded, or the corner portions may be positioned obliquely in plan view (tapered). The second extended electrode portion 24b may have a tapered shape in plan view with an inclination toward one side.

The width of the second facing electrode portion 22b of the second inner electrode 20b and the width of the second extended electrode portion 24b of the second inner electrode 20b may be the same, or one of the widths may be smaller than the other.

The multilayer body 12 includes a side portion 26a between the fifth surface 12e and the ends of the first facing electrode portions 22a and the second facing electrode portions 22b on one side in the second direction z, and a side portion 26b between the sixth surface 12f and the ends of the first facing electrode portions 22a and the second facing electrode portions 22b on the other side in the second direction z. The multilayer body 12 further includes an end portion 27a between the fourth surface 12d and the end portions of the first inner electrodes 20a opposite to the first extended electrode portions 24a, and an end portion 27b between the third surface 12c and the end portions of the second inner electrodes 20b opposite to the second extended electrode portions 24b.

For example, the inner electrodes 20 preferably include Cu as a main component. This configuration reduces the electrical resistance of the inner electrodes 20 and allows the inner electrodes 20 to be formed of an inexpensive material.

The main components of the inner electrodes 20 can be observed as follows.

Specifically, a multilayer ceramic capacitor 10 is polished in the second direction z to a depth of about ½ of the W dimension in the second direction z to expose a cross section. Then, the exposed cross section is observed using TOF-SIMS (available from ION-TOF GmbH) under a condition of an approximately 30 μm square area, for example.

The thickness of each inner electrode 20 is preferably about 0.8 μm or more and about 3.5 μm or less, for example. The total number of the first inner electrodes 20a and the second inner electrodes 20b combined is preferably 2 or more and 30 or less, for example.

The first-surface-side outer layer portion 18a is located on the first surface 12a side of the multilayer body 12 and is a stack of a plurality of outer dielectric layers 14b that are a plurality of dielectric layers 14 located between the first surface 12a and the inner electrode 20 closest to the first surface 12a.

The second-surface-side outer layer portion 18b is located on the second surface 12b side of the multilayer body 12 and is a stack of a plurality of outer dielectric layers 14b that are a plurality of dielectric layers 14 located between the second surface 12b and the inner electrode 20 closest to the second surface 12b.

The region located between the first-surface-side outer layer portion 18a and the second-surface-side outer layer portion 18b is the inner layer portion 16.

The first-surface-side outer layer portion 18a and the second-surface-side outer layer portion 18b are each formed of an insulating material. In the case where the first-surface-side outer layer portion 18a and the second-surface-side outer layer portion 18b are formed of the same kind of dielectric material as the inner dielectric layers 14a, each of the outer layer portions 18a and 18b may be a plurality of outer dielectric layers 14b or a single outer dielectric layer 14b. The outer dielectric layers 14b and the inner dielectric layers 14a may be formed of different compositions. For example, the inner dielectric layers 14a may be formed of a material having a higher permittivity than that of the outer dielectric layers 14b, and the outer dielectric layers 14b may be formed of compositions having excellent moisture resistance, weather resistance, or mechanical strength.

The dimensions of the multilayer body 12 are not particularly limited.

As illustrated in FIGS. 1 to 3, the outer electrodes 30 are on the third surface 12c side and the fourth surface 12d side of the multilayer body 12.

Each outer electrode 30 includes an underlying electrode layer 32 including a metal component and glass, and a plating layer 34 on the surface of the underlying electrode layer 32.

The outer electrodes 30 include a first outer electrode 30a and a second outer electrode 30b.

The first outer electrode 30a is coupled to the first inner electrodes 20a and is disposed at least on the third surface 12c. The first outer electrode 30a extends from the third surface 12c of the multilayer body 12 onto a portion of the first surface 12a, a portion of the second surface 12b, a portion of the fifth surface 12e, and a portion of the sixth surface 12f. In this case, the first outer electrode 30a is electrically coupled to the first extended electrode portions 24a of the first inner electrodes 20a.

The second outer electrode 30b is coupled to the second inner electrodes 20b and is disposed at least on the fourth surface 12d. The second outer electrode 30b extends from the fourth surface 12d of the multilayer body 12 onto a portion of the first surface 12a, a portion of the second surface 12b, a portion of the fifth surface 12e, and a portion of the sixth surface 12f. In this case, the second outer electrode 30b is electrically coupled to the second extended electrode portions 24b of the second inner electrodes 20b.

Inside the multilayer body 12, the first facing electrode portions 22a of the first inner electrodes 20a and the second facing electrode portions 22b of the second inner electrodes 20b face each other with the dielectric layers 14 interposed therebetween to generate capacitance. Accordingly, the capacitance is obtained between the first outer electrode 30a coupled to the first inner electrodes 20a and the second outer electrode 30b coupled to the second inner electrodes 20b to exhibit capacitor characteristics.

The underlying electrode layers 32 include a first underlying electrode layer 32a and a second underlying electrode layer 32b.

The first underlying electrode layer 32a is coupled to the first inner electrodes 20a and is on the third surface 12c. The first underlying electrode layer 32a extends from the third surface 12c onto a portion of the first surface 12a, a portion of the second surface 12b, a portion of the fifth surface 12e, and a portion of the sixth surface 12f. In this case, the first underlying electrode layer 32a is electrically coupled to the first extended electrode portions 24a of the first inner electrodes 20a.

The second underlying electrode layer 32b is coupled to the second inner electrodes 20b and is on the fourth surface 12d. The second underlying electrode layer 32b extends from the fourth surface 12d onto a portion of the first surface 12a, a portion of the second surface 12b, a portion of the fifth surface 12e, and a portion of the sixth surface 12f. In this case, the second underlying electrode layer 32b is electrically coupled to the second extended electrode portions 24b of the second inner electrodes 20b.

The underlying electrode layers 32 include Cu as a main component. The underlying electrode layers 32 include a glass component in addition to Cu, which is a main component. Cu having a low resistivity, included in the underlying electrode layers 32 as a main component, reduces the ESR of the multilayer ceramic capacitor 10. A glass component included in the underlying electrode layers 32 improves sinterability of the underlying electrode layers 32.

The D50 of the Cu particles included in the underlying electrode layers 32 as Cu is preferably about 0.3 μm or more and about 0.6 μm or less, for example. The content of glass component in the underlying electrode layers 32 is preferably about 21 vol % or more and about 25 vol % or less, for example. This configuration suppresses diffusion of Li into the underlying electrode layers 32 in a step of forming the underlying electrode layers described later and reduces the Li content in the underlying electrode layers 32.

The thickness of the first underlying electrode layer 32a, located on the third surface 12c, in the first direction y passing through the third surface 12c and the fourth surface 12d, at a central portion in the lamination direction x is preferably, for example, approximately 19 μm or more and approximately 24 μm or less.

The thickness of the second underlying electrode layer 32b, located on the fourth surface 12d, in the first direction y passing through the third surface 12c and the fourth surface 12d, at a central portion in the lamination direction x is preferably, for example, approximately 19 μm or more and approximately 24 μm or less.

A cross section is obtained by polishing a multilayer ceramic capacitor 10 in the second direction z to a depth of about ½ of the W dimension in the second direction z, and a portion of the underlying electrode layer 32 at the center in the lamination direction x in the cross section is observed using TOF-SIMS (available from ION-TOF GmbH) under a condition of an approximately 30 μm square area with an interface between the multilayer body 12 and the underlying electrode layer 32 positioned at the center of the observation image, for example. In this condition, the Li content in the underlying electrode layer 32 is lower than the Li content in the inner dielectric layers 14a in a region within an approximately 15 μm square area from the interface between the multilayer body 12 and the underlying electrode layer 32. In this case, the Li content in the underlying electrode layer 32 may decrease with an increase in distance in the first direction y from the interface between the multilayer body 12 and the underlying electrode layer 32. Since the Li content in the underlying electrode layer 32 is low in this configuration, reduction in moisture resistance of the multilayer ceramic capacitor 10 can be suppressed. More preferably, in a region within an approximately 5 μm square area from the interface between the multilayer body 12 and the underlying electrode layer 32, the Li content in the underlying electrode layer 32 is preferably lower than the Li content in the inner dielectric layers 14a. Even more preferably, Li is absent in the underlying electrode layer 32. This further suppresses reduction in moisture resistance of the multilayer ceramic capacitor 10.

Specifically, in at least one of a region of the first underlying electrode layer 32a within an approximately 15 μm square area in the first direction y from the interface between the multilayer body 12 and the first underlying electrode layer 32a and a region of the second underlying electrode layer 32b within an approximately 15 μm square area in the first direction y from the interface between the multilayer body 12 and the second underlying electrode layer 32b, the Li content in the first underlying electrode layer 32a and/or the second underlying electrode layer 32b is lower than the Li content in the inner dielectric layers 14a.

Preferably, in at least one of a region of the first underlying electrode layer 32a within an approximately 5 μm square area in the first direction y from the interface between the multilayer body 12 and the first underlying electrode layer 32a and a region of the second underlying electrode layer 32b within an approximately 5 μm square area in the first direction y from the interface between the multilayer body 12 and the second underlying electrode layer 32b, the Li content in the first underlying electrode layer 32a and/or the second underlying electrode layer 32b is lower than the Li content in the inner dielectric layers 14a.

Furthermore, the Li content in the first underlying electrode layer 32a may decrease with an increase in distance in the first direction y from the interface between the multilayer body 12 and the first underlying electrode layer 32a, and the Li content in the second underlying electrode layer 32b may decrease with an increase in distance in the first direction y from the interface between the multilayer body 12 and the second underlying electrode layer 32b.

As described above, the Li content in the underlying electrode layers 32 and the Li content in the inner dielectric layers 14a can be measured by TOF-SIMS (Time-of-Flight Secondary Ion Mass Spectrometry). The measurement conditions for the TOF-SIMS are as follows:
Name of Instrument: TOF-SIMS (available from ION-TOF GmbH)
Primary ion: Bit
Acceleration voltage: 25 kV
Secondary ion polarity: Positive
Number of scans: 32
Number of pixels: 256 pixels×256 pixels
Measurement area: a square of 30 μm×30 μm

The Li content is determined by counting the number of pixels having a Li intensity of 1.0 or more out of 256 pixels×256 pixels.

When a cross section is obtained by polishing a multilayer ceramic capacitor 10 in the second direction z to a depth of about ½ of the W dimension in the second direction z, and a portion of the underlying electrode layer 32 at the center in the lamination direction x in the cross section is observed by using TOF-SIMS (available from ION-TOF GmbH) under a condition of an approximately 30 μm square area with the interface between the multilayer body 12 and the underlying electrode layer 32 positioned at the center of the observation image, Li is absent in regions of the underlying electrode layer 32 more than about 15 μm away from the interface between the multilayer body 12 and the underlying electrode layer 32 in the first direction y away from the multilayer body 12. That is, the distance from the interface between the multilayer body 12 and the underlying electrode layer 32 to Li is about 15 μm or less, for example. Preferably, the distance from the interface between the multilayer body 12 and the underlying electrode layer 32 to Li is about 5 μm or less, for example. Even more preferably, the underlying electrode layer 32 includes no Li. Hence, the amount of Li diffused from the dielectric layers 14 is small, and the Li content in the underlying electrode layer 32 is low, thus decreasing or preventing a reduction in moisture resistance of the multilayer ceramic capacitor 10.

Specifically, Li is absent in at least one of a region of the first underlying electrode layer 32a that is about 15 μm or more away from the interface between the multilayer body 12 and the first underlying electrode layer 32a in the first direction y away from the multilayer body 12 and a region of the second underlying electrode layer 32b that is about 15 μm or more away from the interface between the multilayer body 12 and the second underlying electrode layer 32b in the first direction y away from the multilayer body 12.

Preferably, Li is absent in at least one of a region of the first underlying electrode layer 32a that is about 5 μm or more away from the interface between the multilayer body 12 and the first underlying electrode layer 32a in the first direction y away from the multilayer body 12 and a region of the second underlying electrode layer 32b that is about 5 μm or more away from the interface between the multilayer body 12 and the second underlying electrode layer 32b in the first direction y away from the multilayer body 12.

As described above, the presence or absence of Li in the underlying electrode layers 32 can be determined by TOF-SIMS (Time-of-Flight Secondary Ion Mass Spectrometry). The measurement conditions for the TOF-SIMS are as follows:
Name of Instrument: TOF-SIMS (available from ION-TOF GmbH)
Primary ion: Bi⁺
Acceleration voltage: 25 kV
Secondary ion polarity: Positive
Number of scans: 32
Number of pixels: 256 pixels×256 pixels
Measurement area: a square of 30 μm×30 μm

The presence or absence of Li is determined based on whether any pixel having a Li intensity of about 1.0 or more is present out of 256 pixels×256 pixels, for example.

Next, a first plating layer 34a and a second plating layer 34b, which are the plating layers 34 on the underlying electrode layers 32, will be described with reference to FIGS. 2 and 3.

Each of the first plating layer 34a and the second plating layer 34b includes, for example, at least one selected from Cu, Ni, Sn, Ag, Pd, an Ag—Pd alloy, Au, and the like.

The first plating layer 34a completely covers the first underlying electrode layer 32a.

The second plating layer 34b completely covers the second underlying electrode layer 32b.

The first plating layer 34a and the second plating layer 34b may include a plurality of layers. In this case, each plating layer 34 preferably has a two-layer structure including a lower plating layer (a Ni plating layer) on the underlying electrode layer 32 by Ni plating and an upper plating layer (a Sn plating layer) on the lower plating layer by Sn plating.

That is, in this case, the first plating layer 34a includes a first lower plating layer 36a and a first upper plating layer 38a located on the surface of the first lower plating layer 36a.

The second plating layer 34b includes a second lower plating layer 36b and a second upper plating layer 38b located on the surface of the second lower plating layer 36b.

The lower plating layers 36 formed by Ni plating prevent the underlying electrode layers 32 from being eroded by solder used for mounting the multilayer ceramic capacitor 10, and the upper plating layers 38 formed by Sn plating improve the wettability of solder used for mounting the multilayer ceramic capacitor 10 and facilitate mounting.

The thickness of each of the lower plating layer 36 and the upper plating layer 38 is preferably about 1.0 μm or more and about 15.0 μm or less, for example.

The dimension of the multilayer ceramic capacitor 10 including the multilayer body 12, the first outer electrode 30a, and the second outer electrode 30b in the first direction y is defined as an L dimension, the dimension of the multilayer ceramic capacitor 10 including the multilayer body 12, the first outer electrode 30a, and the second outer electrode 30b in the lamination direction x is defined as a T dimension, and the dimension of the multilayer ceramic capacitor 10 including the multilayer body 12, the first outer electrode 30a, and the second outer electrode 30b in the second direction z is defined as the W dimension.

Regarding the dimensions of the multilayer ceramic capacitor 10, the L dimension in the first direction y is about 0.25 mm or more and about 2.0 mm or less, the W dimension in the second direction z is about 0.125 mm or more and about 1.25 mm or less, and the T dimension in the lamination direction x is about 0.125 mm or more and about 1.25 mm or less, for example. The dimensions of the multilayer ceramic capacitor 10 can be measured using a microscope.

In the multilayer ceramic capacitor 10 illustrated in FIG. 1, since the Li content in the underlying electrode layer 32 in a region within an approximately 15 μm square area from the interface between the multilayer body 12 and the underlying electrode layer 32 is lower than the Li content in the inner dielectric layers 14a, reduction in moisture resistance can be suppressed.

In addition, in the multilayer ceramic capacitor 10 illustrated in FIG. 1, when the Li content in the underlying electrode layer 32 in a region within an approximately 5 μm square area from the interface between the multilayer body 12 and the underlying electrode layer 32 is lower than the Li content in the inner dielectric layers 14a, reduction in moisture resistance can be further suppressed.

In the multilayer ceramic capacitor 10 illustrated in FIG. 1, since Li is absent in regions more than 15 μm away from the interface between the multilayer body 12 and the underlying electrode layer 32 in the first direction y away from the multilayer body 12, reduction in moisture resistance can be suppressed.

Furthermore, in the multilayer ceramic capacitor 10 illustrated in FIG. 1, when the distance from the interface between the multilayer body 12 and the underlying electrode layer 32 to Li is 5 μm or less, reduction in moisture resistance can be further reduced or prevented.

Next, an example of a multilayer ceramic capacitor 10A according to a modification of the first example embodiment of the present invention will be described. FIG. 5 is a schematic sectional view of an example of a multilayer ceramic capacitor according to a modification of the first example embodiment of the present invention. However, components that are the same as or equivalent to those illustrated in FIGS. 1 to 4 are denoted by the same reference numerals, and detailed description thereof is omitted.

The multilayer ceramic capacitor 10A according to the modification of the first example embodiment includes a rectangular parallelepiped multilayer body 12A and outer electrodes 30 disposed at opposite end portions of the multilayer body 12A.

The multilayer body 12A includes a plurality of laminated dielectric layers 14. The multilayer body 12A further includes a first surface 12a and a second surface 12b opposed to each other in a lamination direction x, a third surface 12c and a fourth surface 12d opposed to each other in a first direction y orthogonal to the lamination direction x, and a fifth surface 12e and a sixth surface 12f opposed to each other in a second direction z orthogonal to the lamination direction x and the first direction y.

As illustrated in FIG. 5, the multilayer body 12A includes, as inner electrodes 20, pairs of first inner electrodes 20A and pairs of second inner electrodes 20B.

Each pair of first inner electrodes 20A includes two adjacent first inner electrodes 20a arranged consecutively in the lamination direction x. The pairs of first inner electrodes 20A are electrically coupled to the first outer electrode 30a.

Each pair of second inner electrodes 20B includes two adjacent second inner electrodes 20b arranged consecutively in the lamination direction x. The pairs of second inner electrodes 20B are electrically coupled to the second outer electrode 30b.

This configuration ensures overall conductivity through the plurality of inner electrodes even when the thickness of each inner electrode is small.

The multilayer ceramic capacitor 10A according to the modification of the first example embodiment illustrated in FIG. 5 provides effects the same as or similar to those of the multilayer ceramic capacitor 10 illustrated in FIG. 1.

Next, an example of a multilayer ceramic capacitor 110 according to a second example embodiment of the present invention will be described. FIG. 6 is a perspective view of an example of a multilayer ceramic capacitor according to the second example embodiment of the present invention, illustrating its outer appearance. FIG. 7 is a sectional view taken along line VII-VII in FIG. 6. FIG. 8 is a sectional view taken along line VIII-VIII in FIG. 6. FIG. 9 is a sectional view taken along line IX-IX in FIG. 6.

The multilayer ceramic capacitor 110 according to the second example embodiment of the present invention includes a multilayer body 112 and outer electrodes 30 having configurations the same as or similar to those of the multilayer ceramic capacitor 10 of the first example embodiment. However, in the multilayer ceramic capacitor 110, the magnitude relationship between the L dimension and the W dimension is reversed compared with that of the multilayer ceramic capacitor 10 of the first example embodiment, and hence the W dimension is larger than the L dimension.

The multilayer ceramic capacitor 110 according to the second example embodiment includes the multilayer body 112 having a rectangular parallelepiped shape and the outer electrodes 30 disposed at opposite end portions of the multilayer body 112.

The multilayer body 112 includes a plurality of laminated dielectric layers 14. The multilayer body 112 further has a first surface 112a and a second surface 112b opposed to each other in a lamination direction x, a third surface 112c and a fourth surface 112d opposed to each other in a first direction y orthogonal to the lamination direction x, and a fifth surface 112e and a sixth surface 112f opposed to each other in a second direction z orthogonal to the lamination direction x and the first direction y.

In the multilayer ceramic capacitor 110, the magnitude relationship between the L dimension and the W dimension is reversed compared with that of the multilayer ceramic capacitor 10 of the first example embodiment, and hence the W dimension is larger than the L dimension.

The multilayer ceramic capacitor 110 according to the second example embodiment illustrated in FIG. 6 provides effects the same as or similar to those of the multilayer ceramic capacitor 10 illustrated in FIG. 1.

Next, an example of a multilayer ceramic capacitor 110A according to a modification of the second example embodiment of the present invention will be described. FIG. 10 is a schematic sectional view of an example of a multilayer ceramic capacitor according to the modification of the second example embodiment of the present invention. However, components that are the same as or equivalent to those illustrated in FIGS. 6 to 8 are denoted by the same reference numerals, and detailed description thereof is omitted.

As illustrated in FIG. 10, a multilayer body 112A of the multilayer ceramic capacitor 110A according to the modification of the second example embodiment includes, as inner electrodes 20, pairs of first inner electrodes 20A and pairs of second inner electrodes 20B.

Each pair of first inner electrodes 20A includes two adjacent first inner electrodes 20a arranged consecutively in the lamination direction x. The pairs of first inner electrodes 20A are electrically coupled to the first outer electrode 30a.

Each pair of second inner electrodes 20B includes two adjacent second inner electrodes 20b arranged consecutively in the lamination direction x. The pairs of second inner electrodes 20B are electrically coupled to the second outer electrode 30b.

This configuration ensures overall conductivity through the plurality of inner electrodes even when the thickness of each inner electrode is small.

The multilayer ceramic capacitor 110A according to the modification of the second example embodiment illustrated in FIG. 10 provides effects the same as or similar to those of the multilayer ceramic capacitor 10 illustrated in FIG. 1.

Next, an example of a multilayer ceramic capacitor 210 according to a third example embodiment of the present invention will be described. FIG. 11 is a perspective view of an example of a multilayer ceramic capacitor according to a third example embodiment of the present invention, illustrating its outer appearance. FIG. 12 is a sectional view taken along line XII-XII in FIG. 11. FIG. 13 is a sectional view taken along line XIII-XIII in FIG. 11. FIG. 14 is a sectional view taken along line XIV-XIV in FIG. 11.

The multilayer ceramic capacitor 210 according to the third example embodiment includes a rectangular parallelepiped multilayer body 212 and outer electrodes 30 disposed at opposite end portions of the multilayer body 212.

The multilayer body 212 includes a plurality of laminated dielectric layers 14. The multilayer body 212 further includes a first surface 212a and a second surface 212b opposed to each other in a lamination direction x, a third surface 212c and a fourth surface 212d opposed to each other in a first direction y orthogonal to the lamination direction x, and a fifth surface 212e and a sixth surface 212f opposed to each other in a second direction z orthogonal to the lamination direction x and the first direction y.

As illustrated in FIGS. 13 and 14, the multilayer body 212 includes an inner layer portion 216 in which first inner electrodes 20a and second inner electrodes 20b are on respective dielectric layers 14 with a specified interval therebetween.

The multilayer ceramic capacitor 210 according to the third example embodiment illustrated in FIG. 11 provides effects the same as or similar to those of the multilayer ceramic capacitor 10 illustrated in FIG. 1.

Next, as an example, a method of manufacturing the multilayer ceramic capacitor according to the first example embodiment will be described.

First, ceramic green sheets for dielectric layers and a conductive paste for inner electrodes are prepared. The ceramic green sheets and the conductive paste for inner electrodes include a binder and a solvent. The binder and the solvent may be known ones.

In this process, the ceramic green sheets for inner dielectric layer regions are formed of, for example, a dielectric paste including CaZro₃ and Li. More specifically, this dielectric paste includes at least Ca, Sr, or Zr as a main component, and Li. For example, the dielectric paste includes CaZro₃ or SrZrO₃ as a dielectric component and includes Li as a sintering aid. In addition, the dielectric paste may include Mn, Na, Ti, or the like.

When the dielectric paste for forming the ceramic green sheets for inner dielectric layer regions includes CaZrO₃ as a main component, the amount of Li may be about 0.06 wt % or more and about 0.16 wt % or less relative to CaZrO₃, for example.

Then, the conductive paste for inner electrodes is printed in a specified pattern on the ceramic green sheets for dielectric layers by, for example, screen printing or gravure printing. With this process, ceramic green sheets each having a pattern of the first inner electrode and ceramic green sheets each having a pattern of the second inner electrode are prepared.

Next, a specified number of ceramic green sheets for an outer layer on which no inner electrode pattern is printed are laminated to form a portion serving as the second-surface-side outer layer portion on the second surface side. Then, ceramic green sheets on each of which a pattern of the first inner electrode is printed and ceramic green sheets on each of which a pattern of the second inner electrode is printed are sequentially laminated on the portion serving as the second-surface-side outer layer portion so as to have a structure of the present invention, thereby forming a portion serving as the inner layer portion. A specified number of ceramic green sheets for an outer layer on which no inner electrode pattern is printed are laminated on this portion serving as the inner layer portion, to form a portion serving as the first-surface-side outer layer portion on the first surface side. With these processes, a laminated sheet is formed.

Next, the laminated sheet is pressed in the lamination direction by a method such as isostatic pressing to produce a laminated block.

Then, the laminated block is cut into a specified size to cut out laminated chips serving as the multilayer portions.

Next, the laminated chips are fired to produce fired chips. Specifically, the laminated chips are heated at about 200° C. or higher and about 300° C. or lower, for example. Thereafter, the resultant chips are fired in a non-oxidizing atmosphere at a temperature increase rate of about 3.33° C./min or higher and about 200° C./min or lower and at a maximum firing temperature of 900° C. or higher and about 1040° C. or lower, whereby fired chips are formed, for example.

Next, a conductive paste for forming the underlying electrode layers, including a metal component and a glass component, is prepared.

The prepared conductive paste serving as the underlying electrode layers is applied to the surfaces corresponding to the third surface and the fourth surface of the fired chip, thereby forming the underlying electrode layers. The application of the conductive paste to the surfaces corresponding to the third surface and the fourth surface of the fired chip is performed, for example, by a dipping method or the like. For example, the conductive paste serving as the underlying electrode layers may be prepared so as to contain, as a main component, Cu as a metal component and include a glass component in an amount of about 21 vol % or more and about 25 vol % or less, for example. In this process, the Cu particles may have spherical shapes, and the D50 may be about 0.3 μm or more and about 0.6 μm or less, for example.

Subsequently, the fired chip to which the conductive paste has been applied is fired, thereby forming a fired chip with the underlying electrode layers. In this process, it is preferable to adjust the firing conditions such that, after firing the conductive paste, the underlying electrode layers include an appropriate amount of Li. When firing is performed under conditions such that the underlying electrode layers do not include Li, excessive densification of the underlying electrode layers can be suppressed. Hence, the porosity of the underlying electrode layers is reduced, and the moisture resistance of the multilayer ceramic capacitor can be improved. Further, by limiting diffusion of Li into the underlying electrode layers to, for example, about 15 μm or less from the interfaces between the multilayer body (fired chip) and the underlying electrode layers, excessive densification can be suppressed. If the firing temperature is lowered or the firing time is shortened, the distance and amount of Li diffused into the underlying electrode layers can be reduced. However, densification of the underlying electrode layers becomes insufficient accordingly. Hence, appropriate firing conditions are set such that the state of Li satisfies the configuration of the multilayer ceramic capacitor according to the present invention. For example, firing may be performed under conditions such as in a reducing atmosphere at about 600° C. or higher and about 750° C. or lower for about 0.3 hours or more and about 0.5 hours or less, for example.

Next, as necessary, plating is performed on the surfaces of the underlying electrode layers to form plating layers. In this example embodiment, two plating layers are formed on the surfaces of the underlying electrode layers. Specifically, a Ni plating layer and a Sn plating layer are formed on the underlying electrode layers. As the plating process, electrolytic plating is preferably used. The Ni plating layer and the Sn plating layer are sequentially formed, for example, by barrel plating.

As described above, the multilayer ceramic capacitor 10 according to the present example embodiment is manufactured. Next, in order to confirm the effects of the multilayer ceramic capacitors according to example embodiments of the present invention described above, multilayer ceramic capacitors serving as experimental Samples having different C-axis orientation degrees were produced in accordance with the manufacturing method described above, and an experiment was conducted to determine the presence or absence of cracks through an electrostriction test.

Example specifications of multilayer ceramic capacitors produced as samples for the examples of the experiments will be described below.

Using the above-described manufacturing method according to the example embodiment, multilayer ceramic capacitors serving as samples of sample numbers 1 to 10 were produced.
Dimensions (design values) of the multilayer ceramic capacitor: L×W×T=400 μm×200 μm×200 μm
Ceramic material: CaZrO₃
Material of the inner electrodes: Cu
Underlying electrode layers of the outer electrodes: conductive metal (Cu) and glass component
Thickness of the underlying electrode layer at ½ of the W dimension of the multilayer ceramic capacitor in the second direction z and at the center in the lamination direction x: 20 μm
Plating layers:

Two-layer structure including a Ni plating layer and a Sn plating layer

Thickness of the Ni plating layer: approximately 3 μm

Thickness of the Sn plating layer: approximately 5 μm

Adjustment of the Li diffusion distance from the interface between the multilayer body and the outer electrode was performed in the above-described manufacturing method according to the example embodiment by adjusting the firing time and the firing temperature for the fired chip with the conductive paste. The Li diffusion distance from the interface between the multilayer body and the outer electrode for each sample number is shown in Table 1. For sample number 1, the presence or absence of Li diffusion at the interface between the underlying electrode layer and the plating layer is shown, and sample number 10 indicates that Li was not diffused into the underlying electrode layer (outer electrode).

First, the multilayer ceramic capacitors of each sample number were mounted on a wiring board by using solder, and the insulation resistance values were measured. In this process, the multilayer ceramic capacitors of each sample number mounted on the wiring board were placed in a high-temperature, high-humidity chamber and maintained for 2000 hours in an environment of 85° C. and 85% RH while a DC voltage of 200 V was applied to the outer electrodes of the multilayer ceramic capacitors of each sample number, thereby performing a moisture resistance test. After this moisture resistance test, the insulation resistance was measured for the multilayer ceramic capacitors of each sample number. In the case where the insulation resistance after the moisture resistance test decreased by one order of magnitude or more from the insulation resistance before the moisture resistance test, the result was evaluated as NG. The number of samples for each sample number was 100.

The Li diffusion distance from the interface between the multilayer body and the outer electrode is defined as the Li diffusion distance measured in the underlying electrode layer 32 at the center in the lamination direction x in a cross section obtained by polishing each multilayer ceramic capacitor of each sample number in the second direction z to a depth of about ½ of the W dimension in the second direction z, using TOF-SIMS (available from ION-TOF GmbH) under a condition of an approximately 30 μm square area with the interface between the multilayer body 12 and the underlying electrode layer 32 positioned at the center of the observation image. The presence of Li is determined as follows.

Specifically, the presence or absence of Li in the underlying electrode layer was determined by TOF-SIMS (Time-of-Flight Secondary Ion Mass Spectrometry). The measurement conditions for the TOF-SIMS were as follows:
Name of Instrument: TOF-SIMS (available from ION-TOF GmbH)
Primary ion: Bit
Acceleration voltage: 25 kV
Secondary ion polarity: Positive
Number of scans: 32
Number of pixels: 256 pixels×256 pixels
Measurement area: a square of 30 μm×30 μm

The presence or absence of Li was determined based on whether any pixel having a Li intensity of 1.0 or more was present out of the 256 pixels×256 pixels. For the samples of sample numbers 1 and 2, observation was performed by shifting the center of the observation image.

Table 1 shows, for the multilayer ceramic capacitors of sample numbers 1 to 10, the Li diffusion distance from the interface between the multilayer body and the outer electrode and the results of the moisture resistance test corresponding to the diffusion distance.

TABLE 1

| | Sample Number | | | | | | | | | |
|---|---|---|---|---|---|---|---|---|---|---|
| | 1 | 2 | 3 | 4 | 5 | 6 | 7 | 8 | 9 | 10 |
| Li diffusion distance | 20 | 18 | 15 | 12 | 6 | 5 | 4 | 2 | 1 | 0 |
| from the interface | | | | | | | | | | |
| between the multilayer | | | | | | | | | | |
| body and the outer | | | | | | | | | | |
| electrode (μm) | | | | | | | | | | |
| Moisture resistance | 17/100 | 13/100 | 9/100 | 8/100 | 4/100 | 2/100 | 2/100 | 2/100 | 1/100 | 0/100 |
| test results (pieces) | | | | | | | | | | |

According to Table 1, it was confirmed that as the sample number increases from 1 to 10, the Li diffusion distance from the interface between the multilayer body and the outer electrode decreases, and that as the Li diffusion distance decreases, the number of samples evaluated as NG in the moisture resistance test decreases.

From the above results, it was confirmed that, in an example embodiment of the present invention, as the Li diffusion distance from the interface between the multilayer body and the outer electrode increases, the moisture resistance decreases. The results suggest that degradation in moisture resistance can be suppressed by appropriately distributing lithium (Li) present in the outer electrodes of the multilayer ceramic capacitor.

Although the example embodiments of the present invention are disclosed as above, the present invention is not limited thereto.

In other words, various modifications can be made to the example embodiments described above with respect to mechanisms, shapes, materials, numbers, positions, arrangements, or the like without departing from the technical ideas and the scope of the object of the present invention, and such modifications are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated dielectric layers, a plurality of laminated inner electrodes, a first surface and a second surface opposed to each other in a lamination direction, a third surface and a fourth surface opposed to each other in a first direction orthogonal to the lamination direction, and a fifth surface and a sixth surface opposed to each other in a second direction orthogonal to the lamination direction and the first direction;
a first outer electrode on the third surface of the multilayer body; and
a second outer electrode on the fourth surface of the multilayer body; wherein
the multilayer body includes:
an inner layer portion; and
two outer layer portions on opposite sides of the inner layer portion in the lamination direction;
the inner layer portion includes:
a first inner electrode with one end portion exposed at the third surface;
a second inner electrode with one end portion exposed at the fourth surface; and
an inner dielectric layer provided with the first inner electrode and the second inner electrode;
the inner dielectric layer includes at least Ca, Sr, or Zr as a main component, and Li; and
in at least one of a region of the first outer electrode within an approximately 15 μm square area in the first direction from an interface between the multilayer body and the first outer electrode and a region of the second outer electrode within an approximately 15 μm square area in the first direction from an interface between the multilayer body and the second outer electrode, a Li content in the first outer electrode and/or the second outer electrode is less than a Li content in the inner dielectric layer.

2. The multilayer ceramic capacitor according to claim 1, wherein in at least one of a region of the first outer electrode within an approximately 5 μm square area in the first direction from the interface between the multilayer body and the first outer electrode and a region of the second outer electrode within an approximately 5 μm square area in the first direction from the interface between the multilayer body and the second outer electrode, the Li content in the first outer electrode and/or the second outer electrode is less than the Li content in the inner dielectric layer.

3. The multilayer ceramic capacitor according to claim 1, wherein in at least one of a region of the first outer electrode that is about 5 μm or more away from the interface between the multilayer body and the first outer electrode in the first direction away from the multilayer body and a region of the second outer electrode that is about 5 μm or more away from the interface between the multilayer body and the second outer electrode in the first direction away from the multilayer body, Li is not present.

4. The multilayer ceramic capacitor according to claim 1, wherein the inner electrodes include Cu.

5. The multilayer ceramic capacitor according to claim 1, wherein
a Li content in the first outer electrode decreases with an increase in distance in the first direction from the interface between the multilayer body and the first outer electrode; and/or
a Li content in the second outer electrode decreases with an increase in distance in the first direction from the interface between the multilayer body and the second outer electrode.

6. The multilayer ceramic capacitor according to claim 1, wherein
at least one of the first outer electrode and the second outer electrode includes Cu particles as a main component and a glass component;
a D50 of the Cu particles is about 0.3 μm or more and about 0.6 μm or less; and
a content of the glass component is about 21 vol % or more and about 25 vol % or less.

7. The multilayer ceramic capacitor according to claim 1, wherein at least one of the first outer electrode and the second outer electrode does not include Li.

8. The multilayer ceramic capacitor according to claim 1, wherein in at least one of a region of the first outer electrode that is about 15 μm or more away from the interface between the multilayer body and the first outer electrode in the first direction away from the multilayer body and a region of the second outer electrode that is about 15 μm or more away from the interface between the multilayer body and the second outer electrode in the first direction away from the multilayer body, Li is not present.

9. The multilayer ceramic capacitor according to claim 1, wherein a length of the multilayer ceramic capacitor is larger than a width dimension of the multilayer capacitor, or the width of the multilayer ceramic capacitor is larger than the length dimension of the multilayer capacitor.

10. The multilayer ceramic capacitor according to claim 1, wherein the first inner electrode includes a pair of first inner electrodes and two adjacent first inner electrodes arranged consecutively in the lamination direction, and the second inner electrode includes a pair of second inner electrodes and two adjacent second inner electrodes arranged consecutively in the lamination direction.

11. A multilayer ceramic capacitor comprising:
a multilayer body including a plurality of laminated dielectric layers, a plurality of laminated inner electrodes, a first surface and a second surface opposed to each other in a lamination direction, a third surface and a fourth surface opposed to each other in a first direction orthogonal to the lamination direction, and a fifth surface and a sixth surface opposed to each other in a second direction orthogonal to the lamination direction and the first direction;
a first outer electrode on the third surface of the multilayer body; and
a second outer electrode on the fourth surface of the multilayer body; wherein
the multilayer body includes:
an inner layer portion; and
two outer layer portions on opposite sides of the inner layer portion in the lamination direction;
the inner layer portion includes:
a first inner electrode with one end portion exposed at the third surface;
a second inner electrode with one end portion exposed at the fourth surface; and
an inner dielectric layer provided with the first inner electrode and the second inner electrode;
the inner dielectric layer includes at least Ca, Sr, or Zr as a main component, and Li; and
in at least one of a region of the first outer electrode that is about 15 μm or more away from an interface between the multilayer body and the first outer electrode in the first direction away from the multilayer body and a region of the second outer electrode that is about 15 μm or more away from an interface between the multilayer body and the second outer electrode in the first direction away from the multilayer body, Li is not present.

12. The multilayer ceramic capacitor according to claim 11, wherein in at least one of a region of the first outer electrode within an approximately 5 μm square area in the first direction from the interface between the multilayer body and the first outer electrode and a region of the second outer electrode within an approximately 5 μm square area in the first direction from the interface between the multilayer body and the second outer electrode, the Li content in the first outer electrode and/or the second outer electrode is less than the Li content in the inner dielectric layer.

13. The multilayer ceramic capacitor according to claim 11, wherein in at least one of a region of the first outer electrode that is about 5 μm or more away from the interface between the multilayer body and the first outer electrode in the first direction away from the multilayer body and a region of the second outer electrode that is about 5 μm or more away from the interface between the multilayer body and the second outer electrode in the first direction away from the multilayer body, Li is not present.

14. The multilayer ceramic capacitor according to claim 11, wherein the inner electrodes include Cu.

15. The multilayer ceramic capacitor according to claim 11, wherein
a Li content in the first outer electrode decreases with an increase in distance in the first direction from the interface between the multilayer body and the first outer electrode; and/or
a Li content in the second outer electrode decreases with an increase in distance in the first direction from the interface between the multilayer body and the second outer electrode.

16. The multilayer ceramic capacitor according to claim 11, wherein
at least one of the first outer electrode and the second outer electrode includes Cu particles as a main component and a glass component;
a D50 of the Cu particles is about 0.3 μm or more and about 0.6 μm or less; and
a content of the glass component is about 21 vol % or more and about 25 vol % or less.

17. The multilayer ceramic capacitor according to claim 11, wherein at least one of the first outer electrode and the second outer electrode does not include Li.

18. The multilayer ceramic capacitor according to claim 11, wherein in at least one of a region of the first outer electrode that is about 15 μm or more away from the interface between the multilayer body and the first outer electrode in the first direction away from the multilayer body and a region of the second outer electrode that is about 15 μm or more away from the interface between the multilayer body and the second outer electrode in the first direction away from the multilayer body, Li is not present.

19. The multilayer ceramic capacitor according to claim 11, wherein a length of the multilayer ceramic capacitor is larger than a width dimension of the multilayer capacitor, or the width of the multilayer ceramic capacitor is larger than the length dimension of the multilayer capacitor.

20. The multilayer ceramic capacitor according to claim 11, wherein the first inner electrode includes a pair of first inner electrodes and two adjacent first inner electrodes arranged consecutively in the lamination direction, and the second inner electrode includes a pair of second inner electrodes and two adjacent second inner electrodes arranged consecutively in the lamination direction.
